(19) United States
(12) Patent Application Publication
(10) Pub. No.: US 2009/0122261 A1
(43) Pub. Date: May 14, 2009

(54) Reflective Polarized Lenses With High Transmission

(75) Inventors: Hsin-Hsin Chou, Woodbury, MN (US); Hideyo Sugimura, North Oaks, MN (US); Len Meissner, Stillwater, MN (US)

Correspondence Address: INSKEEP INTELLECTUAL PROPERTY GROUP, INC, 2281 W. 190TH STREET, SUITE 200, TORRANCE, CA, 90504, US

(73) Assignee: Insight Equity A.P.X., L.P.

(21) Appl. No.: 12/266,823

(22) Filed: Nov. 7, 2008

Related U.S. Application Data
(60) Provisional application No. 60/986,932, filed on Nov. 9, 2007.

(51) Int. Cl. G02C 7/12; G02B 5/30; G02B 5/23; B29C 65/48; G02C 7/10

(52) U.S. Cl. 351/163; 359/493; 359/241; 516/60

(57) ABSTRACT

The present invention relates to unique reflective polarized lenses that are anti-dazzling and reduce glare. In particular, it relates to polarized lenses utilizing a reflective polarizer, a high-transmission absorptive polarizer and photochromic treatment in a unique combination that can be injection molded to make thermoplastic ophthalmic lenses. The resulting lenses have high luminous transmission, high polarization efficiency for use in sunglasses and has potential applications for night vision

### RELATED APPLICATIONS

This application claims priority to U.S. Provisional Application Ser. No. 60/986,932, filed Nov. 9, 2007, entitled Reflective Polarized Lenses with High Transmission, which is hereby incorporated by reference.

### FIELD OF THE INVENTION

The field of invention is that of plastic ophthalmic eyewear, corrective eyewear, and spectacle lenses that transmit polarized light.

### BACKGROUND OF THE INVENTION

Glare can be described as brightness from an excess of visible light. There are four types of glare that tend to impair or otherwise affect vision: distracting glare, discomforting glare, disabling glare, and blinding glare. Distracting glare can be caused by car headlights or streetlights at night or by the reflection of light off the front or back of optical lenses. At night, it may result in halos observed around bright lights. Distracting glare may cause eye fatigue and distraction. Discomforting glare can be caused by normal sunlight condition or other situations in which light intensity in the surrounding environment increases from low 1000 lumens to 3000 lumens and above. This glare may result in squinting and increased ocular discomfort. Disabling glare is caused by illuminating light intensity that increases to above 10,000 lumens or more, for example when facing directly into the sun. This type of glare causes objects to appear to have lower contrast, reducing visual acuity and raising the differential threshold. The effects of disabling glare can last beyond the duration of exposure. Blinding glare is caused by incident light reflecting from smooth shiny surfaces such as, water, sand or snow and becoming plane polarized. It can block vision and cause visual compromise.

Anti-reflective, or AR, coatings applied to lens surfaces can reduce distracting glare. Ophthalmic and fashion lenses and eyewear can also be treated with processes that impart a fixed tint to reduce the light transmission of the lens. Another type of lens treatment is a variable photochromic tint that incorporates photochromic dyes into or onto the surface of lens. The photochromic dyes reduce the light transmission of the lens when the lens is exposed to ultraviolet, or UV, radiation. A third type of lens treatment is the incorporation of a fixed tint polarizing, or PZ, layer or film into or onto the lens. Incorporation of a fixed tint polarizing layer results in transmitting light through the lens having only one polarizing axis and blocking out light having an axis that is 90 degrees to that of the polarizing axis of the layer or film.

Discomforting glare can be reduced through the use of photochromic treatments, light tints, or low optical density/high transmittance polarizing lenses. Photochromic treatments, dark tints, and high optical density/low transmittance polarizing lenses are needed to reduce disabling glare reduction. The blinding glare can only be significantly reduced or eliminated through high polarizing efficiency PZ lenses. Generally speaking, the higher the polarizing efficiency of a layer or film, the more efficient the polarizing layer is at blocking out light with an axis perpendicular to the PZ axis of the layer of film.

Photochromic treatments, in addition to being considered fashionable in some markets, are also quite useful in the reduction of two types of glares: discomforting and disabling. However, most photochromic treatments can only be activated by UV light of the solar spectrum to start the darkening process. The mechanism is rendered inactive when inside a car because car windows filter and absorb most of the necessary short wavelength UV light for photochromic activation. Without polarizing capability and with darkening process incapacitated, photochromic treatments become useless to reduce the various glares encountered while driving.

Polarized lenses offer a unique alternative for improving vision. However, being a static device, polarized lenses do not adjust to varying lighting conditions. Furthermore, polarized lenses do not generally achieve the same desirable fashion status enjoyed by lenses having photochromic treatments.

In order to resolve the needs of optical performance as well as to satisfy the stylish urge of some markets, there is a need in the optical lens field to combine the functionalities of photochromic treatments and polarizing layers. Examples of attempts to provide such lenses are present in the prior art, for example: Trident Polarized Delta Photochromic lenses by Spy Optic, Inc.; Transhades lenses by KBco; and Camel lenses by Julbo, inc. These lenses all take advantage of the functionalities of combining photochromic and polarizing technologies. Further examples of such lenses and methods for making them include: U.S. Pat. No. 7,256,921, which discloses employing polarizing photochromic dyes, and U.S. Pat. Nos. 7,256,921, 5,625,427, 6,145,984, 7,035,010, 7,128,415, and 7,256,921, which disclose combining regular photochromic treatments with polarizing layers, all of which are hereby incorporated by reference. The combination of regular absorptive polarizer and photochromic treatments has been tried with and without reduced polarizing efficiency.

Those combination lenses that utilize high optical density absorptive polarizing treatments may reduce glare and provide sufficient transmission in full sunlight exposure but typically do not provide enough transmittance under low light conditions, such as during a cloudy day or at night. The glare experienced in nighttime conditions is predominantly distracting glare. The application of anti-reflective coatings on lenses reduces the reflections off the surface of the lens, yet reflections in the form of halos caused by direct headlights can only be reduced through greater light intensity reduction. However, concerns have been raised about whether it is safe to use high tints or high optical density absorptive polarizing lenses for driving in low light conditions.

In response to all these considerations, a high-transmission photochromic treatment and polarizing layer combination lens is needed. U.S. Pat. No. 6,926,405, which is hereby incorporated by reference, discloses an optical lens having selective spectral response photochromic treatments. The spectral response photochromic treatments are utilized in combination with a high-transmission absorptive polarizer to offer a high-transmission, spectral-varying photochromic treatment and polarizer combination lens. Due to the polarizer layer or film utilized, these lenses could not be manufactured through injection molding process.

Mirrored surfaces increase the fashionable character of sun lenses in some markets, as well as reduce or eliminate UV and infrared light. However, polarizing photochromic lenses, such as those disclosed in U.S. Pat. No. 6,926,405, which is hereby incorporated by reference, cannot be mirrored. Mirrored surfaces reduce visible light and will further reduce the photochromic action of the lens when used inside a car. The reduction is dependent upon the density of the mirror treatment. Utilization of a very light flash mirror may let enough visible light reach the lens photochromic treatment to activate the lens, but such a lens' response darkness would be reduced. It is known that silver flash mirrors reduce transmission about 10 to 15 percent. Other very intense and reflective mirror treatments reduce visible light transmission to an even greater extent and will reduce the overall effectiveness of the lens. Furthermore, lenses mirrored on the front surface tend to produce a high overall back surface reflection that interferes with vision through the lens. Employment of a neutral density filter on the back surface of the lens may reduce back reflection, however, the neutral density filter will also reduce overall light transmission proportionally.

Accordingly, there is a need for a lens that simultaneously provides: (a) excellent glare reduction; (b) high polarization efficiency to reduce glare and properly enhance color and luminous contrast; (c) photochromic function (variable tint when exposed to UV) with high-transmission when the photochromic function is in the clear state; (d) efficiency in manufacturing by being injection moldable; (e) mirror-type reflective convex surface without affecting other functions; and (f) low back-surface reflection.

### OBJECTS AND SUMMARY OF THE INVENTION

The present invention overcomes the shortcomings of the prior art by employing a unique functional laminate comprising a reflective polarizer and absorptive polarizer combination. Lenses incorporating functional laminates according to the present invention have high luminous transmission, high polarization efficiency for use in sunglasses and potential applications for night vision. Furthermore, such lenses may appear mirror-like in certain conditions, yet have a law level of back reflectance.

### BRIEF DESCRIPTION OF THE DRAWINGS

FIG. 1A is a perspective view showing the various layers of a functional laminate according to certain embodiments of the present invention;

FIG. 1B is a cross-sectional view showing the various layers of a functional laminate according to certain embodiments of the present invention;

FIG. 2A is a perspective view showing the various layers of a functional laminate according to certain embodiments of the present invention; and

FIG. 2B is a cross-sectional view showing the various layers of a functional laminate according to certain embodiments of the present invention.

### DESCRIPTION OF EMBODIMENTS

Specific embodiments of the invention will now be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

According to certain embodiments of the present invention, a reflective polarizing functional laminate is provided that is particularly useful for attachment to a lens or lens blank through standard injection molding, thermal set, and photopolymerization processes. Such processes are described in U.S. Pat. No. 6,328,446, which is hereby incorporated by reference. The functional laminate employs a high-efficiency, reflective polarizer attached to a high-transmission polarizer. Various combinations of adhesives and photochromic dye-containing adhesives may also be employed in the laminate. For the sake of clarity, descriptions of the various layers of the different functional laminates of the present invention will begin with the outer most or outside layer, i.e. the layer that would be furthest away from the eye of a person looking through a lens employing the functional laminate. Descriptions will proceed stepwise through each layer towards the eye, or towards the inside or innermost layer.

Lenses incorporating functional laminates according to the present invention provide significant advantages over prior art lenses, including: high-transmission (approximately 40 percent); high polarization efficiency (greater than or equal to 99 percent); potential applications for night vision; photochromic and polarized functionality; reduced glare inside automobiles; enhanced contrast outdoors; various tinting options including brown or grey tinting; desirable styling; and metallic and dynamic color.

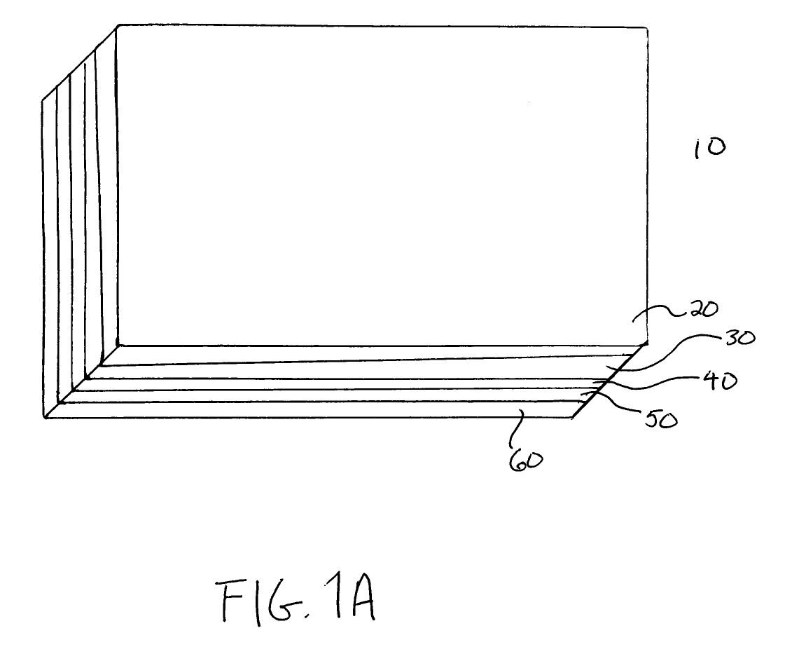

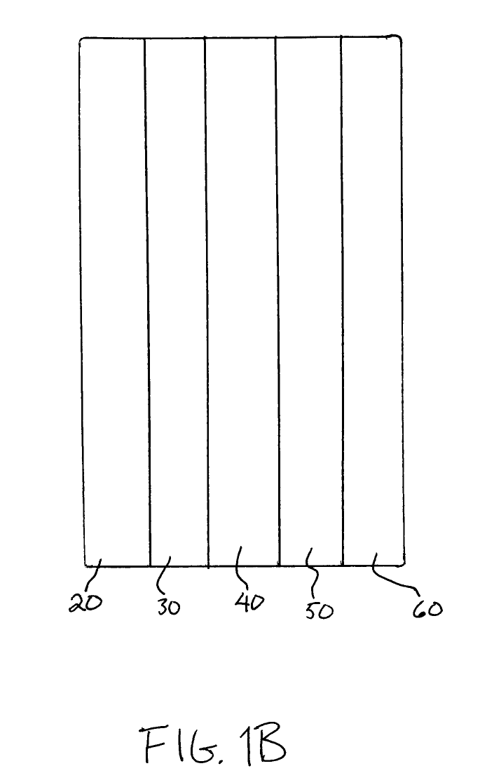

As illustrated in FIGS. 1A and B, a laminate 10, according to one embodiment of the present invention, employs a five-layer configuration. The outside layer is a reflective polarizer 20. Following the reflective polarizer 20 is a photochromic dye-containing adhesive layer 30. Next, a high-transmission, low-polarizing efficiency polarizer 40 is employed which is followed by an adhesive layer 50 and, finally, a polycarbonate film 60. A lens incorporating the above described functional laminate 10 appears silvery, reflective and semi-transparent indoors, mirror-like outdoors, and gradually transitions between the indoor and outdoor states.

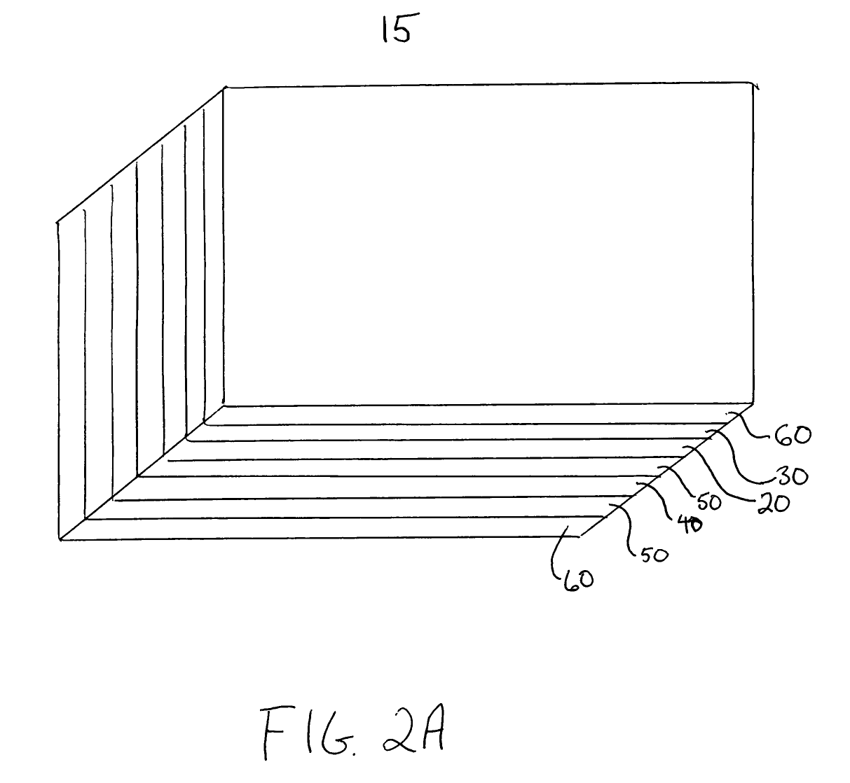

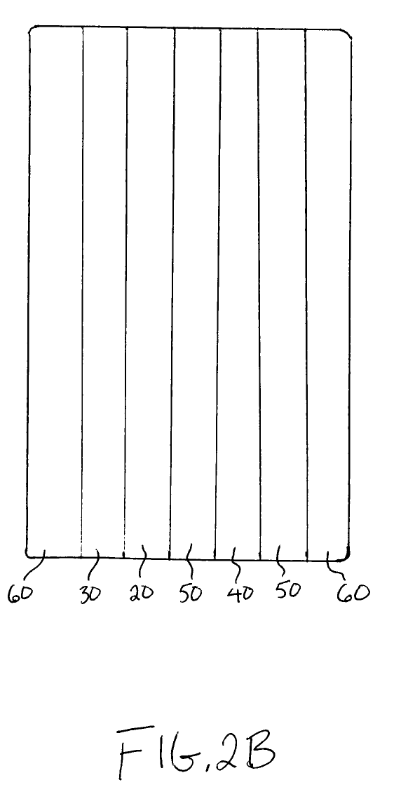

In a second embodiment of the present invention, as illustrated in FIGS. 2A and B, a functional laminate 15 employs a seven-layer configuration. The first or outside layer is a polycarbonate film 60. The photochromic dye-containing adhesive layer 30 is employed next followed by the reflective polarizer 20. Next is an adhesive layer 50, a high-transmission, low-polarizing efficiency polarizer 40, another adhesive layer 50, and, lastly another polycarbonate film 60. A lens incorporating the functional laminate 15 according to this embodiment appears silvery, reflective and semi-transparent indoors, dark or heavily tinted outdoors, and gradually transitions between indoor and outdoor states.

A polycarbonate film may be employed to improve the adhesion of the polarizer to the molded lens blank. The polarizer can be adhered to a polycarbonate film using an adhesive, for example a polyurethane adhesive. In certain other embodiments of the laminates and lenses of the present invention, additional layers or films, such as non-birefringent CAB, cellulose acetate butyrate, or highly-retardant films are attached in front of the reflective polarizer, i.e. on the outside of the laminate.

A reflective polarizer, or RPZ, is a film structure that polarizes reflected light. An example of a reflective polarizer suitable for employment in the functional laminates and lenses according to the present invention may be, but is not limited to, the Vacuity Dual Brightness Enhancement Film (DBEF) sold by the 3M company. More particularly, the 3M DBEBF-E, 0 degree film may be employed. As will be appreciated, reflective polarizers, such as the DBEF-E, efficiently reflect light incident upon either side of the film. Therefore, in order to control for undesirably high levels of backside reflection, i.e. reflection off the backside of the a lens towards the eye, lenses incorporating functional laminates according to the present invention, incorporate a high-transmission absorptive polarizer on the backside of the reflective polarizer. The high-transmission polarizer is oriented to have a polarizing axis parallel to the polarizing axis of the reflective polarizer.

A high-transmission polarizer suitable for employment in laminates and lenses according to the present invention may be chosen from those polarizers known in the field. Such filters may be referenced according to a conventional “Axx” reference scheme, in which “A” refers to a film of a specific color or tint, and the “xx” references a percent transmission of unpolarized white light. For example, G50 is a polarizer that is grey in color and has a transmission ratio of approximately 50 percent and a polarizing efficiency of approximately 83 percent. More particularly, various high-transmission, polarizers that may be employed in the laminates and lenses according to the present invention include: grey G35 and G50; brown B35 and B50; HEV, or high-energy visible, brown H18, H35, and H50.

With respect to the adhesive layers employed in functional laminates and lenses according to the present invention, a variety of adhesives including, but not limited to, polyurethane adhesives are widely known in the field and suitable for use. In those adhesive layers further incorporating a photochromic dye or dyes, the specific photochromic dyes utilized should be chosen according to the color characteristics of the high-transmission polarizer also being employed in the laminate. For example if the high-transmission polarizer is a brown or HEV brown, a brown or HEV brown photochromic dye should also be used.

Photochromic dye-containing adhesive composition and methods for making the same are widely know in the field and described in U.S. Pat. Nos. 6,328,446, 5,757,459, 5,856,860, 5,827,614, 6,814,896, 6,506,538, 7,036,932, 7,048,997, and 7,077,985, all of which are hereby incorporated by reference. For lens applications in which improved nighttime vision is desired, photochromic functionality and tinting may be greatly reduced or omitted entirely from the laminate. In such applications, the adhesive employed need not contain photochromic dye or dyes. Alternatively, in a single-laminate configuration, various adhesive layers may be employed, some containing photochromic dye or dyes and other not containing photochromic dyes.

Table 1 summarizes the data from Examples 1-3 presented below. The table compares the percent transmission and back-reflectance, i.e. the reflection measured off the back of the lens as if towards an eye, of various configurations of functional laminates according to the present invention. Table 1 also provides a break down of the components of the total back-reflectance, high-transmission polarizer (HTPZ) and reflective polarizer (RPZ). The reflective polarizer back reflection component of laminates employing both a high-transmission polarizer and a reflective polarizer represents a calculated value, the back-reflectance of a laminate employing both a high-transmission polarizer and a reflective polarizer minus the back-reflectance of a relevant laminate employing only a high-transmission polarizer.

As previously described, G35 and G50 are grey polarizers having a percent transmission of 35 and 50 percent respectively. H18 is a high-energy visible brown polarizer having a percent transmission of unpolarized white light of 18 percent. Also included in the comparison is corresponding data as measured for a laminate employing a neutral density filter and a laminate employing a neutral density filter in combination with a reflective polarizer. The neutral density filter, NDF, utilized was an ND30 chromafilter obtained from Performance Coatings International.

TABLE 1
Summary Table

| | Transmission | Back Reflectance | Back Reflectance | Back Reflectance |
|---|---|---|---|---|
| Laminate | (%) | (Total) | (HTPZ) | (RPZ) |
| RPZ | 47.10 | 51.24 | | |
| G35 | 35.11 | 6.10 | | |
| RPZ + G35 | 32.45 | 6.52 | 6.1 | 0.42 |
| G50 | 49.53 | 5.97 | | |
| RPZ + G50 | 40.85 | 8.08 | 5.97 | 2.11 |
| NDF | 27.2 | 4.69 | | |
| RPZ + NDF | 14.29 | 7.94 | 4.69 | 3.25 |
| H18 | 18 | 5.51 | | |
| RPZ + H18 | 17.12 | 5.66 | 5.51 | 0.15 |

As evident from Table 1, the back-reflectance of a laminate combining a reflective polarizer and a neutral density filter, RPZ+NDF, is substantially close to the back reflectance of a laminate combining a reflective polarizer and the high-transmission polarizer G50, RPZ+G50. However, the transmission ratio of the RPZ+NDF is only 14.3 percent whereas the transmission ratio of the RPZ+G50 laminate is approximately 40 percent. The low transmission ratio of the RPZ/NDF laminate renders it undesirable for certain applications where high transmission is necessary.

The reflective polarizers used in the following experiments were 3M's DBEF-E films. The film has an embossed pattern on one surface to facilitate easy film separation from other film stacked on top for LCD applications. Similar films not having the embossed pattern are available in the field. The total film thickness was approximately 5.2 mil. A HunterLab UltraScan XE colorimeter was used to measure the transmission and back reflection of unpolarized white light for each of the functional laminate configurations provided in Table 1.

Polarization efficiency (h) was determined by the formula: h=((T₉₀−T₀)/(T₉₀+T₀))^{1/2}, where T₉₀ was the transmission of vertical polarized light and T₀ was the transmission of horizontally polarized light.

### EXAMPLE 1

A comparison was conducted using various combinations of reflective polarizers, high-transmission, low-efficiency polarizers and regular polymer polarizers. The high-transmission, low-efficiency polarizer G35 was pre-laminated in two stretched polycarbonate films. G50 was a dyed polyvinyl alcohol, PVA, film. The RPZ+G50 and RPZ+35 laminates were obtained by laminating G35 or G50 film to reflective polarizers with the polarizing axes of each polarizer aligned to the one another. The results of the comparison are provided in Table 2.

TABLE 2

| | | Back Reflectance | Polarization |
|---|---|---|---|
| Laminate | Transmission (%) | (Total) | Efficiency |
| PZ (regular) | 17.55 | 5.23 | 99.9 |
| RPZ | 47.1 | 51.24 | 93.6 |
| G35 | 35.11 | 6.1 | 97.5 |
| RPZ + G35 | 32.45 | 6.52 | 99.9 |
| G50 | 49.53 | 5.97 | 83.6 |
| RPZ + G50 | 40.85 | 8.08 | 99.7 |

It is noted that the high back reflection of the reflective polarizer when used alone, 51.24 percent was reduced to level of a back reflection normal for a regular polymer polarizing film, approximately 5 percent, when the reflective polarizer was combined with a high-transmission, low-efficiency polarizer. This observed reduction in back reflectance was achieved without experiencing significant transmission reduction. Compared to the regular polymer polarizer laminate, the RPZ+G35 or G50 laminate had similar high polarization efficiency and yet had two to three times higher transmission. PZ(regular) refers to a regular absorptive, high polarization efficiency polarizer commonly used in a conventional polarizing sunglass.

### EXAMPLE 2

A second comparison was conducted using a high-transmission polarizer alone and in combination with a reflective polarizer. The high-transmission polarizer H18 is a HEV Brown polarizer with 18 percent luminous transmission. The RPZ+H18 laminate was constructed by laminating the H18 film to a reflective polarizer with the polarizing axes of each polarizer aligned to one another. The results of the comparison are provided in Table 3.

TABLE 3

| | | Back Reflectance | Polarization |
|---|---|---|---|
| Laminate | Transmission (%) | (Total) | Efficiency |
| H18 | 18 | 5.51 | 97.1 |
| RPZ + H18 | 17.12 | 5.66 | 98.7 |

### EXAMPLE 3

A third comparison was conducted using a neutral density filter alone and in combination with a reflective polarizer. The neutral density filter used was ND30, a Chromafilter from obtained from Performance Coatings International. ND30 has a luminous transmission of approximately 30 percent. The test laminate RPZ+ND30 is obtained by laminating ND30 film to a reflective polarizer. The results of the comparison are provided in Table 4.

TABLE 4

| | | Back Reflectance | Polarization |
|---|---|---|---|
| Laminate | Transmission (%) | (Total) | Efficiency |
| ND30 | 27.2 | 4.69 | 0 |
| RPZ + ND30 | 14.29 | 7.94 | 96.4 |

It is seen that even though the utilization of a neutral density filter is able to reduce the reflection from a RPZ from 51% to ˜8%, similar to the utilization of a G50 polarizer. However, the luminous transmission has also been reduced from 47% to a mere 14% as compared to 40% when a G50 polarizer has been used.

### EXAMPLE 4

In the first injection molding experiment, an additional polycarbonate film was also attached to the functional laminate to increase the stiffness of the laminate for easier robotic arm vacuum pick-up during loading. The configuration of the functional laminate beginning from the outside layer was: reflective polarizer; photochromic dye-containing polyurethane adhesive; high-transmission, low-efficiency polarizer G50; polyurethane adhesive; 12 mil polycarbonate film. The laminates were cut into 86 mm diameter disks for flanged lens molding. The reflective polarizer was facing out after injection molding. The press used was set up for molding 4 base semi-finished single vision (SFSV) lenses. A polycarbonate resin (Teijin Chemicals, 3500 Parkway Lane, Suite 310, Norcross, Ga. 30092, USA) was used for molding. For molding the reflective polarizing, photochromic lenses, the Mold H front temperature was lowered to 250° F. because the front layer of the reflective polarizer has a melting temperature at 250° F.

The molded SV RPZ lens had very uniform polarization efficiency across the lens. It was of cosmetically and optically good quality. The lens' outside or front surface became mirror-like and reflective when the photochromic layer was activated with a significant dynamic color change. The activation time in direct sunlight was much longer than a regular photochromic lens due to partial UV absorption by the reflective polarizer film. The lens was subjected to Tegra hard coating and curing process. The hard coat remained intact after a tint and adhesion cross-hatch peeling test.

### EXAMPLE 5

The functional laminate for the second injection molding experiment had the following configuration: polycarbonate; photochromic dye-containing polyurethane adhesive; reflective polarizer; polyurethane adhesive; high-transmission, low-efficiency polarizer G35 (26.5 mil). The G35 high-transmission, low-efficiency polarizer comprised a polycarbonate-poly vinyl alcohol-polycarbonate laminate film. The injection molding press was set up to make 4 base single vision (SV) photochromic lenses. The mold front temperature was set at 290° F.

The molded SV reflective polarizing, photochromic lens had very uniform polarization efficiency across the lens. It was of cosmetically and optically good quality. The lens front surface was silvery indoors and became black-like when the photochromic layer was activated outdoors. The photochromic activation time outdoors was similar to that of a regular photochromic lens. The reflective polarizing lens was subjected to Tegra hard coating and curing process. The hard coat remained intact after a tint and adhesion cross hatch peeling test.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. An optical functional laminate comprising:
a first functional layer comprising a reflective polarizer; and
a second functional layer attached to the first functional layer.

2. The optical functional laminate of claim 1, wherein the second functional layer comprises a functional layer selected from a group of functional layers consisting of: a polarizing layer and a photochromic layer.

3. The optical functional laminate of claim 2, wherein the polarizing layer comprises a high-transmission polarizer.

4. The optical functional laminate of claim 2, wherein the photochromic layer comprises a photochromic dye-containing adhesive layer.

5. The optical functional laminate of claim 3, wherein the photochromic dye-containing adhesive layer comprises a polyurethane.

6. The optical functional laminate of claim 1, wherein the second functional layer comprises a high-energy visible blocking component.

7. The optical functional laminate of claim 1, further comprising additional layers selected from a group of layers consisting of: a non-bifringement polymer layer, a highly retardant layer, a stretched polycarbonate layer, anti-reflection layer, a hard coat layer, and an anti-fog layer.

8. The optical functional laminate of claim 1, further comprising a third functional layer.

9. The optical functional laminate of claim 8, wherein the third function layer comprises an functional layer selected from a group of functional layers consisting of: a polarizing layer and a photochromic layer.

10. The optical functional laminate of claim 9, wherein the polarizing layer comprises a high-transmission polarizer.

11. The optical functional laminate of claim 9, wherein the photochromic layer comprises a photochromic dye-containing adhesive layer.

12. The optical functional laminate of claim 11, wherein the photochromic dye-containing adhesive layer comprises a polyurethane.

13. The optical functional laminate of claim 9, wherein the photochromic layer comprises a photochromic dye selected according to a color characteristic of the second functional layer.

14. The optical functional laminate of claim 8, wherein the third functional layer comprises a high-energy visible blocking component.

15. The optical functional laminate of claim 8, wherein the first functional layer is attached to a first side of the second functional layer and the third functional layer is attached to a second side of the second functional layer.

16. The optical functional laminate of claim 8, wherein the second functional layer is attached to a first side of the first functional layer and the third functional layer is attached to a second side of the first functional layer.

17. A method for making an optical laminate, the method comprising the steps of:
providing a first functional layer comprising a reflective polarizer; and
attaching a second functional layer to said first functional layer.

18. The method of claim 17, wherein the step of attaching a second functional layer comprises attaching a functional layer selected from the group of functional layers consisting of: a photochromic adhesive and a polarizing layer.

19. The method of claim 17, further comprising attaching a third functional layer comprising a functional layer selected from a group of functional layers consisting of: a photochromic adhesive and a polarizing layer

20. The method of claim 19, wherein the step of attaching a third functional layer comprises attaching the third functional layer to a side of the second functional layer opposite the first functional layer.

21. The method of claim 19, wherein the step of attaching a third functional layer comprises attaching the third functional layer to side of the first functional layer opposite the second functional layer.

22. An optical lens comprising:
a hardened resin; and
a functional laminate attached to the hardened resin, the functional laminate comprising:
a first functional layer comprising a reflective polarizer; and
a second functional layer.

23. The optical lens of claim 22, wherein the second functional layer comprises of a functional layer selected from a group of functional layers consisting of: a polarizing layer and a photochromic layer.

24. The optical lens of claim 22, wherein the functional laminate further comprises a third functional layer comprising of a functional layer selected from a group of functional layers consisting of: a polarizing layer and a photochromic layer.

25. The optical lens of claim 22, wherein the lens is treated with a treatment selected from a group of treatments consisting of: an anti-reflection treatment, a hard coat treatment, and an anti-fog treatment
